(19) United States
(12) Patent Application Publication
(10) Pub. No.: US 2026/0170470 A1
(43) Pub. Date: Jun. 18, 2026

(54) METHOD AND SYSTEM FOR TAGGING AUTOMATED CLEARING HOUSE TRANSACTIONS

(71) Applicant: JPMorgan Chase Bank, N.A., New York, NY (US)

(72) Inventors: Kevin BICHOUPAN, Great Neck, NY (US); Nicholas CHIZZONITE, Downingtown, PA (US); Christopher SOTELO, Chicago, IL (US); Justin GIANG, Columbus, OH (US); Matthew POZMANTER, Durham, NC (US); Matthew FRIEND, San Rafael, CA (US); Virginia CHAPPELL, Denver, CO (US); Andrew MANSFIELD, Wyckoff, NJ (US); Azam KHALFE, Brooklyn, NY (US); Shayan TABATABAI, Brooklyn, NY (US)

(73) Assignee: JPMorgan Chase Bank, N.A., New York, NY (US)

(21) Appl. No.: 19/395,891

(22) Filed: Nov. 20, 2025

Related U.S. Application Data
(60) Provisional application No. 63/735,004, filed on Dec. 17, 2024.

(51) Int. Cl. G06Q 20/02; G06N 20/00

(52) U.S. Cl. CPC G06Q 20/023; G06N 20/00

(57) ABSTRACT

A method and a system for tagging an automated clearing house transaction are provided. The method includes: accessing raw transaction data that includes a merchant name and a transaction description for each transaction; removing extraneous characters from the raw transaction data; separating the raw transaction data into a first subset of raw transaction data and a second subset of raw transaction data; applying a set of enrichment rules to the first subset of the raw transaction data to generate a first enriched data set; transmitting the first enriched data set to a data asset set; training a large language model using the data asset set; and assigning, via the LLM, a standardized merchant name, an industry, a use case, and a transaction type to each transaction from the second subset of the raw transaction data to generate a second enriched data set.

### CROSS-REFERENCE TO RELATED APPLICATIONS

This application claims priority benefit from U.S. Provisional Application No. 63/735,004, filed on Dec. 17, 2024, in the U.S. Patent and Trademark Office, which is hereby incorporated by reference in its entirety.

### FIELD OF THE DISCLOSURE

This disclosure generally relates to methods and systems for tagging an automated clearing house (ACH) transaction, and more particularly to methods and systems for enriching raw transaction data by appending transactional tags that contain useful information for categorizing and analyzing ACH transactions.

### BACKGROUND INFORMATION

Currently, ACH transactions come with very little useful information and data appended to the transaction. Thus, banks/firms have very little context and data to discern or evaluate each transaction. Additionally, the data that is appended to each transaction often is not standardized within a single entity. For example, a sample of multiple transactions from a single company, business, or merchant might have different variations of the merchant name for each separate transaction. Moreover, there is currently no method or system to enhance raw transaction data by appending standardized and useful information to ACH transactions. Also, current ACH transaction review processes face issues with inconsistent analysis, difficulty in data manipulation, and feedback. Particularly, these issues stem from a lack of consistent, reliable, and contextual information among current ACH transaction reliant systems and result in inefficient system resource usage issues due to the lack of consistency and integration of useful information among the systems.

Accordingly, there is a need to generate and append tagging data to ACH transactions. Particularly, a service is needed for generating a large number of useful transaction tagging information by utilizing both a rule based and machine learning system that continuously learns and generates better and more useful tags to provide banks with a greater understanding and context for each transaction.

### SUMMARY

The present disclosure, through one or more of its various aspects, embodiments, and/or specific features or sub-components, provides, inter alia, various systems, servers, devices, methods, media, programs, and platforms for enriching raw transaction data by appending transactional tags that contain useful information for categorizing and analyzing ACH transactions.

According to an aspect of the present disclosure, a method for tagging an ACH transaction is provided. The method may be implemented by at least one processor. The method may include: accessing, by the at least one processor, raw transaction data that includes a respective merchant name and a respective transaction description for each respective transaction from the raw transaction data; removing, by the at least one processor, extraneous characters from the raw transaction data; separating, by the at least one processor, the raw transaction data into a first subset of raw transaction data and a second subset of raw transaction data; applying, by the at least one processor, a set of enrichment rules to the first subset of the raw transaction data to generate a first enriched data set, wherein the applying of the set of enrichment rules includes assigning a respective standardized merchant name, assigning a respective industry, assigning a respective use case, and assigning a respective transaction type to each respective transaction from the first subset of the raw transaction data, and wherein the first enriched data set is a consolidation of the results from the applying of the set of enrichment rules; transmitting, by the at least one processor, the first enriched data set to a data asset set; training, by the at least one processor, a large language model (LLM) using the data asset set to perform assigning standardized merchant names, assigning industries, assigning use cases, and assigning transaction types to unenriched data; and assigning, by the at least one processor via the LLM, a respective standardized merchant name, a respective industry, a respective use case, and a respective transaction type to each respective transaction from the second subset of the raw transaction data to generate a second enriched data set, wherein the second enriched data set is a consolidation of the results from the assigning.

The method may further include calculating, by the at least one processor via the LLM, a respective confidence score for each of the assigning of the respective standardized merchant name, the assigning of the respective industry, the assigning of the respective use case, and the assigning of the respective transaction type for each respective transaction from the second enriched data set; determining, by the at least one processor via the LLM, whether each respective confidence score is above a predetermined threshold; and transmitting, by the at least one processor, each respective assignment having a corresponding confidence score above the predetermined threshold to a model enriched data set.

Each respective assignment having a corresponding confidence score below the predetermined threshold may be transmitted back to the LLM model for re-assigning of a respective standardized merchant name, a respective industry, a respective use case, and a respective transaction type.

The model enriched data set may be fed into the data asset set and used for the training of the LLM model.

The LLM model may be configured to compare each respective transaction of the second subset of raw transaction data to each respective transaction of the data asset set to determine whether the respective transaction of the second subset of raw transaction data is similar to the respective transaction of the data asset set, and wherein the assigning may be based on each respective transaction of the data asset set that is determined to be similar to the respective transaction of the second subset of raw transaction data.

The extraneous characters may include at least one from among at least one punctuation and at least one acronym.

The assigning of the respective industry may be based on the respective merchant name and the respective transaction description.

The assigning of the respective use case may be based on the respective merchant name, the respective transaction description, and the respective assigned industry.

The assigning of the respective transaction type may be based on the respective merchant name, the respective transaction description, and the respective assigned industry.

According to another aspect of the present disclosure, a computing apparatus for tagging an ACH transaction is provided. The computing apparatus may include a processor; a memory; and a communication interface coupled to each of the processor, and the memory. The processor may be configured to: access raw transaction data that includes a respective merchant name and a respective transaction description for each respective transaction from the raw transaction data; remove extraneous characters from the raw transaction data; separate the raw transaction data into a first subset of raw transaction data and a second subset of raw transaction data; apply a set of enrichment rules to the first subset of the raw transaction data to generate a first enriched data set, wherein the applying of the set of enrichment rules includes assigning a respective standardized merchant name, assigning a respective industry, assigning a respective use case, and assigning a respective transaction type to each respective transaction from the first subset of the raw transaction data, and wherein the first enriched data set is a consolidation of the results from the applying of the set of enrichment rules; transmit the first enriched data set to a data asset set; train an LLM using the data asset set to perform assigning standardized merchant names, assigning industries, assigning use cases, and assigning transaction types to unenriched data; and assign, via the LLM, a respective standardized merchant name, a respective industry, a respective use case, and a respective transaction type to each respective transaction from the second subset of the raw transaction data to generate a second enriched data set, wherein the second enriched data set is a consolidation of the results from the assigning.

The processor may be further configured to calculate, via the LLM, a respective confidence score for each of the assigning of the respective standardized merchant name, the assigning of the respective industry, the assigning of the respective use case, and the assigning of the respective transaction type for each respective transaction from the second enriched data set; determine, via the LLM, whether each respective confidence score is above a predetermined threshold; and transmit each respective assignment having a corresponding confidence score above the predetermined threshold to a model enriched data set.

Each respective assignment that has a corresponding confidence score below the predetermined threshold may be transmitted back to the LLM model for re-assigning of a respective standardized merchant name, a respective industry, a respective use case, and a respective transaction type.

The model enriched data set may be fed into the data asset set and used for the training of the LLM model.

The LLM model may be configured to compare each respective transaction of the second subset of raw transaction data to each respective transaction of the data asset set to determine whether the respective transaction of the second subset of raw transaction data is similar to the respective transaction of the data asset set, and wherein the assigning may be based on each respective transaction of the data asset set that is determined to be similar to the respective transaction of the second subset of raw transaction data.

The extraneous characters may include at least one from among at least one punctuation and at least one acronym.

The assigning of the respective industry may be based on the respective merchant name and the respective transaction description.

The assigning of the respective use case may be based on the respective merchant name, the respective transaction description, and the respective assigned industry.

The assigning of the respective transaction type may be based on the respective merchant name, the respective transaction description, and the respective assigned industry.

According to yet another aspect of the present disclosure, a non-transitory computer readable storage medium storing instructions for tagging an ACH transaction is provided. The storage medium includes executable code which, when executed by a processor, may cause the processor to: access raw transaction data that includes a respective merchant name and a respective transaction description for each respective transaction from the raw transaction data; remove extraneous characters from the raw transaction data; separate the raw transaction data into a first subset of raw transaction data and a second subset of raw transaction data; apply a set of enrichment rules to the first subset of the raw transaction data to generate a first enriched data set, wherein the applying of the set of enrichment rules includes assigning a respective standardized merchant name, assigning a respective industry, assigning a respective use case, and assigning a respective transaction type to each respective transaction from the first subset of the raw transaction data, and wherein the first enriched data set is a consolidation of the results from the applying of the set of enrichment rules; transmit the first enriched data set to a data asset set; train a LLM using the data asset set to perform assigning standardized merchant names, assigning industries, assigning use cases, and assigning transaction types to unenriched data; and assign, via the LLM, a respective standardized merchant name, a respective industry, a respective use case, and a respective transaction type to each respective transaction from the second subset of the raw transaction data to generate a second enriched data set, wherein the second enriched data set is a consolidation of the results from the assigning.

The executable code may further cause the processor to: calculate, via the LLM, a respective confidence score for each of the assigning of the respective standardized merchant name, the assigning of the respective industry, the assigning of the respective use case, and the assigning of the respective transaction type for each respective transaction from the second enriched data set; determine, via the LLM, whether each respective confidence score is above a predetermined threshold; and transmit each respective assignment having a corresponding confidence score above the predetermined threshold to a model enriched data set.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for enriching raw transaction data by appending transactional tags that contain useful information for categorizing and analyzing ACH transactions, according to an embodiment.

FIG. 2 illustrates a diagram of a network environment for enriching raw transaction data by appending transactional tags that contain useful information for categorizing and analyzing ACH transactions, according to an embodiment.

FIG. 3 illustrates a system diagram of a system for enriching raw transaction data by appending transactional tags that contain useful information for categorizing and analyzing ACH transactions, according to an embodiment.

FIG. 4 illustrates a process diagram of a process for enriching raw transaction data by appending transactional tags that contain useful information for categorizing and analyzing ACH transactions, according to an embodiment.

FIG. 5 illustrates a flow diagram of a process for enriching raw transaction data by appending transactional tags that contain useful information for categorizing and analyzing ACH transactions, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units, and/or modules of the example embodiments may be physically combined into more complex blocks, units, and/or modules without departing from the scope of the present disclosure.

A system or method disclosed herein generates consistent, reliable, and contextual information among ACH transactions that increases speed, efficiency, consistency, and accuracy among ACH transaction reliant systems. For instance, the system may access raw transaction data, apply a series of rules to a subset of the raw transaction data to append appropriate tags, train a machine learning model based on the applying of the rules and the appending of the tags, and use the machine learning model to apply appropriate tags to the remaining data. Particularly, the system may access a large number of raw transaction data. The system may remove extraneous characters from the raw transaction data to create a cleaned version of the raw transaction data. The system may then apply a set of enrichment rules to a subset of the cleaned version of the raw transaction data, such that a series of tags are applied to each respective transaction of the raw transaction data. The series of tags may include a standardized merchant name, an industry, a use case, and a transaction type of each respective transaction. Then, the system may train an LLM model using information from the subset of transaction data in which the series of tags were applied based on the enrichment rules. The trained LLM may then apply the series of tags to each transaction of the remaining transaction data in which the series of tags were not previously applied. The LLM may continuously assess and learn from the tagging in order to apply subsequent tags to transaction data.

By leveraging a set of enrichment rules and a trained LLM system, the system may be able to provide and append tags to a stream of ACH transactions as they are received. The appended tags make it easier to analyze, process, categorize, and contextualize ACH transactions. Thus, the system allows for the tagging of useful information that provide banks and users with a greater understanding and context for each transaction and improve synchronization and efficiency of system resource usage issues by generating and integrating useful information.

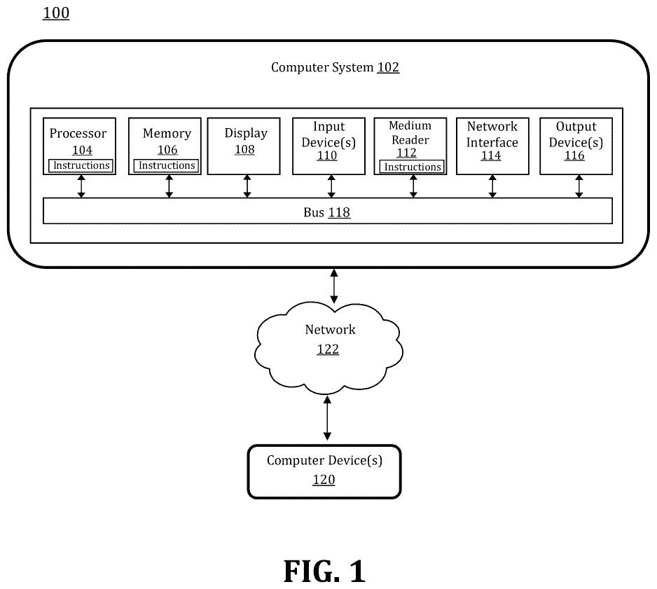

FIG. 1 is a system 100 for enriching raw transaction data by appending transactional tags that contain useful information for categorizing and analyzing ACH transactions, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive. In some embodiments, the ACH transaction tagging module implemented by the system 100 may allow for enriching raw transaction data by appending transactional tags that contain useful information for categorizing and analyzing ACH transactions. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

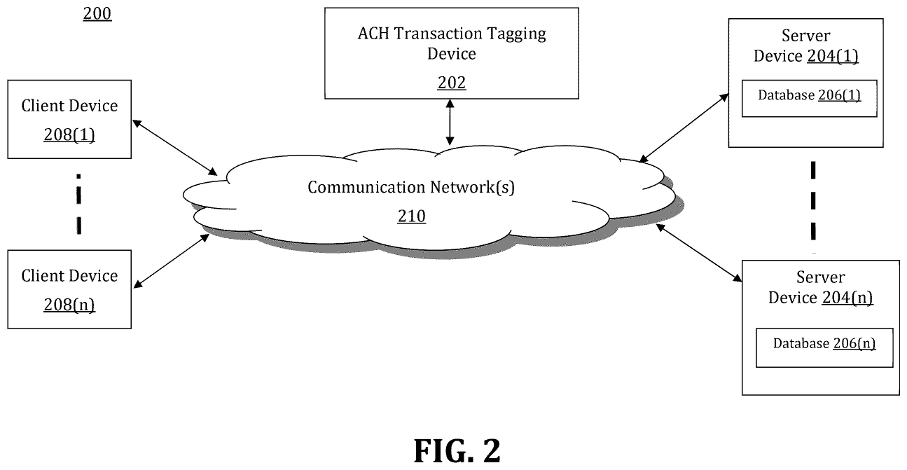

Referring to FIG. 2, a schematic of a network environment 200 for enriching raw transaction data by appending transactional tags that contain useful information for categorizing and analyzing ACH transactions is illustrated.

In some embodiments, the above-described problems associated with conventional tools may be overcome by implementing an ACH transaction tagging device 202 as illustrated in FIG. 2 that may be configured for enriching raw transaction data by appending transactional tags that contain useful information for categorizing and analyzing ACH transactions, but the disclosure is not limited thereto.

The ACH transaction tagging device 202 may include one or more computer systems 102, as described with respect to FIG. 1, which in aggregate provide the necessary functions.

The ACH transaction tagging device 202 may store one or more applications that can include executable instructions that, when executed by the ACH transaction tagging device 202, cause the ACH transaction tagging device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ACH transaction tagging device 202 itself, may be located in virtual server(s) running in a cloud-based computing environment rather than being tied to one or more specific physical network computing devices. Also, the application(s) may be running in one or more virtual machines (VMs) executing on the ACH transaction tagging device 202. Additionally, in one or more embodiments of this technology, virtual machine(s) running on the ACH transaction tagging device 202 may be managed or supervised by a hypervisor.

In the network environment 200 of FIG. 2, the ACH transaction tagging device 202 may be coupled to a plurality of server devices 204(1)-204(n) that hosts a plurality of databases 206(1)-206(n), and also to a plurality of client devices 208(1)-208(n) via communication network(s) 210. A communication interface of the ACH transaction tagging device 202, such as the network interface 114 of the computer system 102 of FIG. 1, operatively couples and communicates between the ACH transaction tagging device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ACH transaction tagging device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ACH transaction tagging device 202 may be a standalone device or integrated with one or more other devices or apparatuses, such as one or more of the server devices 204(1)-204(n), for example. In one example, the ACH transaction tagging device 202 may be hosted by one of the server devices 204(1)-204(n), and other arrangements are also possible. Moreover, one or more of the devices of the ACH transaction tagging device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the authentication device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the ACH transaction tagging device 202 that may enrich raw transaction data by appending transactional tags that contain useful information for categorizing and analyzing ACH transactions, but the disclosure is not limited thereto.

The client devices 208(1)-208(n) may run interface applications, such as standard web browsers or standalone client applications, which may provide an interface to communicate with the ACH transaction tagging device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the ACH transaction tagging device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the ACH transaction tagging device 202, the server devices 204(1)-204(n), or the client devices 208(1)-208(n), for example, may be configured to operate as virtual instances on the same physical machine. For example, one or more of the ACH transaction tagging devices 202, the server devices 204(1)-204(n), or the client devices 208(1)-208(n) may operate on the same physical device rather than as separate devices communicating through communication network(s) 210. Additionally, there may be more or fewer ACH transaction tagging devices 202, server devices 204(1)-204(n), or client devices 208(1)-208(n) than illustrated in FIG. 2. In some embodiments, the ACH transaction tagging device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

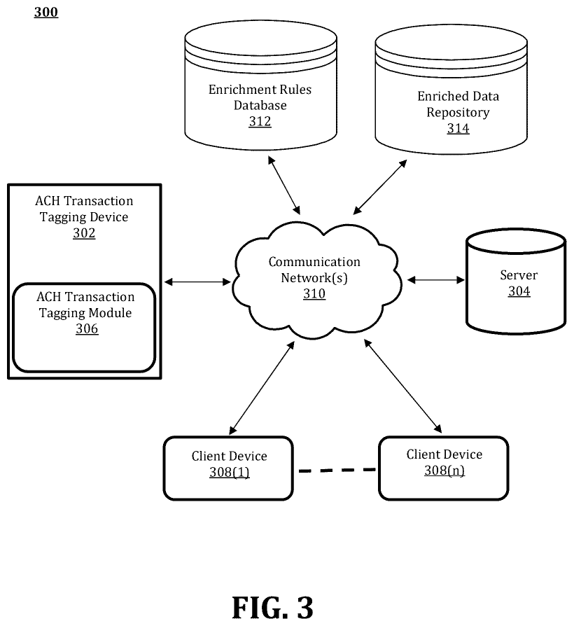

FIG. 3 illustrates a system diagram for enriching raw transaction data by appending transactional tags that contain useful information for categorizing and analyzing ACH transactions.

As illustrated in FIG. 3, the system 300 may include an ACH transaction tagging device 302 within which an ACH transaction tagging device module 306 is embedded, a server 304, an enrichment rules database 312, an enriched data repository 314, a plurality of client devices 308(1) . . . 308(n), and a communication network 310.

In some embodiments, the ACH transaction tagging device 302 including the ACH transaction tagging module 306 may be connected to the server 304, the enrichment rules database 312, and the enriched data repository 314 via the communication network 310. The ACH transaction tagging device 302 may also be connected to the plurality of client devices 308(1) . . . 308(n) via the communication network 310, but the disclosure is not limited thereto. The enrichment rules database 312 and the enriched data repository 314 may include one or more repositories or databases.

In an embodiment, the ACH transaction tagging device 302 is described and shown in FIG. 3 as including the ACH transaction tagging module 306, although it may include other rules, policies, modules, databases, or applications, for example. In some embodiments, the enrichment rules database 312 and the enriched data repository 314 may be configured to store ready to use modules written for each API for all environments. Although only one database and one repository are illustrated in FIG. 3, the disclosure is not limited thereto. Any number of desired databases and/or repositories may be utilized for use in the disclosed invention herein. The enrichment rules database 312 and the enriched data repository 314 may be a mainframe database, a log database that may produce programming for searching, monitoring, and analyzing machine-generated data via a web interface, but the disclosure is not limited thereto. In addition, the enrichment rules database 312 and the enriched data repository 314 may store a plurality of data sets and predictive models for enriching raw transaction data by appending transactional tags.

In some embodiments, the ACH transaction tagging module 306 may be configured to receive real-time feed of data from the plurality of client devices 308(1) . . . 308(n) and secondary sources via the communication network 310.

The ACH transaction tagging module 306 may be configured to: access raw transaction data that includes a respective merchant name and a respective transaction description for each respective transaction from the raw transaction data; remove extraneous characters from the raw transaction data; separate the raw transaction data into a first subset of raw transaction data and a second subset of raw transaction data; apply a set of enrichment rules to the first subset of the raw transaction data to generate a first enriched data set, wherein the applying of the set of enrichment rules includes assigning a respective standardized merchant name, assigning a respective industry, assigning a respective use case, and assigning a respective transaction type to each respective transaction from the first subset of the raw transaction data; transmit the first enriched data set to a data asset set; train an LLM using the data asset set to perform assigning standardized merchant names, assigning industries, assigning use cases, and assigning transaction types to unenriched data; and assign, via the LLM, a respective standardized merchant name, a respective industry, a respective use case, and a respective transaction type to each respective transaction from the second subset of the raw transaction data to generate a second enriched data set.

The plurality of client devices 308(1) . . . 308(n) are illustrated as being in communication with the ACH transaction tagging device 302. In this regard, the plurality of client devices 308(1) . . . 308(n) may be “clients” (e.g., customers) of the data transformation device 302 and are described herein as such. Nevertheless, it is to be known and understood that the plurality of client devices 308(1) . . . 308(n) need not necessarily be “clients” of the ACH transaction tagging device 302, or any entity described in association therewith herein. Any additional or alternative relationship may exist between either or both plurality of client devices 308(1) . . . 308(n) and the ACH transaction tagging device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the ACH transaction tagging device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The ACH transaction tagging device 302 may be the same or similar to the ACH transaction tagging device 202 as described with respect to FIG. 2, including any features or combination of features described with respect thereto.

Upon being started, the ACH transaction tagging device 302 executes a process for enriching raw transaction data by appending transactional tags that contain useful information for categorizing and analyzing ACH transactions.

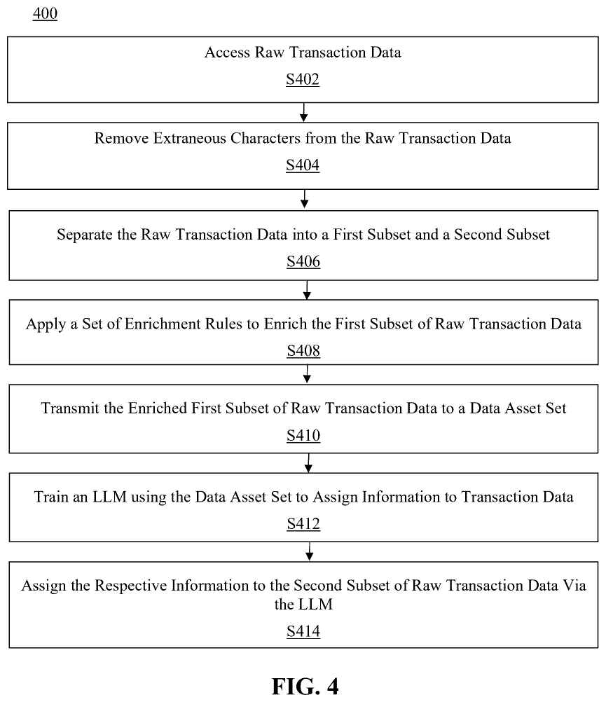

FIG. 4 illustrates a process 400 for enriching raw transaction data by appending transactional tags that contain useful information for categorizing and analyzing ACH transactions.

In process 400 of FIG. 4, at step S402, the ACH transaction tagging device 302 may be configured to access raw transaction data. The raw transaction data may be ACH transaction data. The raw transaction data may include a respective merchant name and/or a respective transaction description for each respective transaction from the raw transaction data. In an embodiment, the raw transaction data may be accessed from a banking platform, an ACH database or repository, and/or a consumer information database (e.g., Integrated Consumer Data Warehouse (ICDW)). The raw transaction data may be broken down to the individual transaction level. In some embodiments, the information associated with the raw transaction data may include at least one from among a unique transaction identifier, an account number of a debited account and a credited account, the routing number of the debited account and the credited account, the transaction posting date, the transaction posting sequence number, the transaction amount, the transaction description, the debit account holder name, the credit account holder name, the transaction Standard Entry Class (SEC) code, an internal or external transaction designator, a scenario code, and an entity type logic.

At step S404, the ACH transaction tagging device 302 may be configured to remove extraneous characters from the raw transaction data. For example, in some embodiments, the ACH transaction tagging device 302 may be configured to remove punctuations and acronyms (e.g., LLC, CORP, etc.) from the merchant name to generate a respective clean name (i.e., the merchant name in which punctuations and acronyms have been removed) and remove punctuations and acronyms (e.g., LLC, CORP, etc.) from the transcription descriptions to generate a respective clean description (i.e., the transaction description in which punctuations and acronyms have been removed) for each transaction from the raw transaction data.

At step S406, the ACH transaction tagging device 302 may be configured to separate the raw transaction data into first and second subsets. In an embodiment, the first subset of data may be a percentage of the raw transaction data, and the second subset may be the remaining transactions from the raw transaction data. In some embodiments, the first subset may be a relatively small percentage of the raw transaction data. For example, according to an embodiment, the first subset may be 40% or less of the raw transaction data and the second subset may be the remaining portion of the raw transaction data. Moreover, in an embodiment, the first subset may be 30% or less, 20% or less, 10% or less, or 5% or less of the raw transaction data.

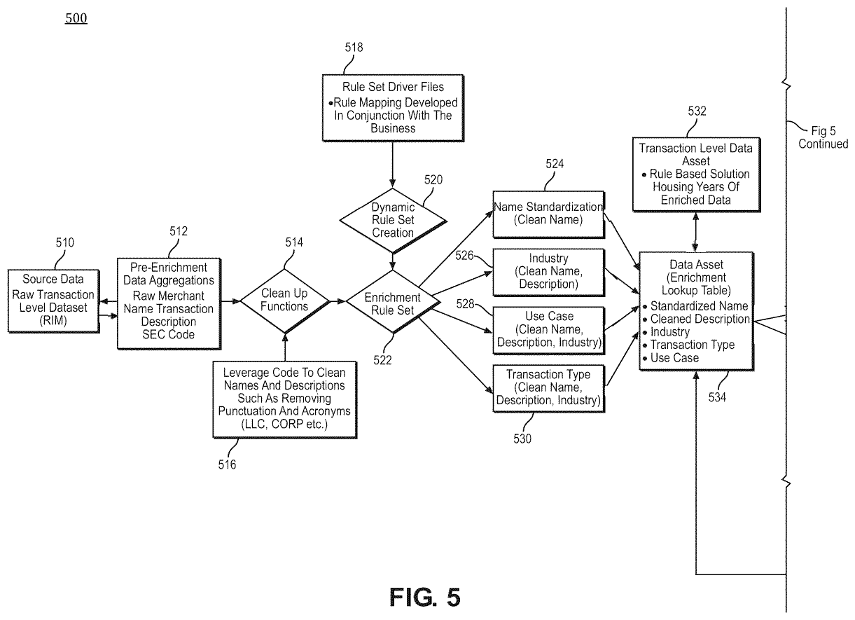

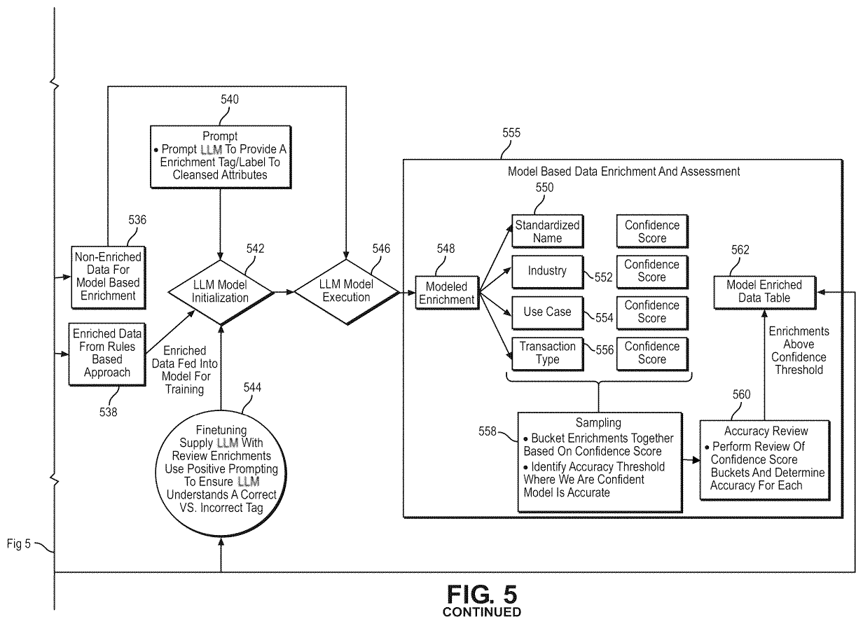

At step S408, the ACH transaction tagging device 302 may be configured to apply a set of enrichment rules to the first subset of the raw transaction data to generate a first enriched data set. The set of enrichment rules may be applied by a rules-based engine. The application of the rules-based engine is illustrated by modules 514-530 of FIG. 5, as described below. In an embodiment, the set of enrichment rules may include a set of instructions for assigning a set of tags/information to the raw transactions. For example, according to an embodiment, by applying the set of enrichment rules, the ACH transaction tagging device 302 may be configured to assign at least one from among a respective standardized merchant name, a respective industry, a respective use case, and a respective transaction type to each respective transaction from the first subset of the raw transaction data. In an embodiment, name standardization allows for a merchant that is represented by a plurality of different names across different transactions involving the same merchant to be standardized to a single standardized name. For example, a single merchant may be represented as “ABC cards” in one transaction, “ABC Loan” in a second transaction, and “ABC online” in a third the transaction. In this example, the ACH transaction tagging device 302 may be configured to assign a standardized name of “ABC” across all three transactions. In some embodiments, the assigning of the respective industry may be based on the respective merchant's name and the respective transaction description. And the assigning of the respective use case may be based on the respective merchant's name, the respective transaction description, and the respective assigned industry. The assigning of the respective transaction type may be based on the respective merchant's name, the respective transaction description, and the respective assigned industry.

In an embodiment, the ACH transaction tagging device 302 may be configured to utilize a software library (e.g., pandas) for data manipulation and ingestion by extracting aggregated data from the raw transaction data into respective categories. For example, the raw merchant's name and the account information may be extracted and used to generate the respective standardized merchant names. The standardized merchant name, the clean description, and the account information may be extracted and used to generate the respective industry type. The standardized merchant name, the SEC code, the clean description, the industry type, and the account information may be extracted and used to generate the respective use case. Additionally, the standardized merchant name, the SEC code, the clean description, the industry type, and the account information may be extracted and used to generate the respective transaction type.

At step S410, the ACH transaction tagging device 302 may be configured to transmit the first enriched data set to a data asset set. The data asset set may be a database of enriched data. In an embodiment, the data asset set may include an enrichment lookup table for searching and analyzing each of the standardized merchant names, the clean descriptions, the industries, the transaction types, and the use cases. In some embodiments, the data asset set may be a table that is published in software package or platform (e.g., Snowflake) to easily access and analyze the enriched data.

At step S412, the ACH transaction tagging device 302 may be configured to train an LLM using the data asset set for assigning information to transaction data. In an embodiment, the LLM may be trained to assign standardized merchant names, industries, use cases, and transaction types to unenriched data. The LLM may be continuously fed with new enriched data for further training of the LLM.

Then, at step S414, the ACH transaction tagging device 302, via the LLM, may be configured to assign a respective standardized merchant name, a respective industry, a respective use case, and a respective transaction type to each respective transaction from the second subset of the raw transaction data to generate a second enriched data set. The ACH transaction tagging device 302 may be configured to compile each of the confidence scores for each respective enrichment of the data set to determine respective overall confidence scores. The confidence scores for each respective enrichment represent how likely it is that the generated respective assigned enrichments (e.g., standardized merchant name, industry, use case, or transaction type) are accurate. The overall confidence score represents how likely it is that all the enrichments for that respective transaction are accurate. The confidence scores may be a percentage from 0% to 100%. With a larger percentage indicating a greater chance that the enrichment is accurate. The ACH transaction tagging device 302 may be configured to determine whether each respective overall confidence score is above a predetermined threshold value. Each transaction having an overall confidence score that is at or above the predetermined threshold value may then be transmitted to a model enriched data set. Each respective transaction having an overall confidence score that is below the predetermined threshold value may be sent back to the LLM, so that the LLM may re-assign information to each respective transaction. In an embodiment, the model enriched data set may be fed into the data asset set and used for the training of the LLM model.

In some embodiments, the LLM model may be configured to compare each respective transaction of the second subset of raw transaction data to each respective transaction of the data asset set to determine whether the respective transaction of the second subset of raw transaction data is similar to the respective transaction of the data asset set. Thus, the tagging/assigning of information may be based on each respective transaction of the data asset set that is determined to be similar to the respective transaction of the second subset of raw transaction data, in order to increase the accuracy of the assigning of the information. In an embodiment, the LLM may be used to provide a quantitative metric (i.e., confidence score (e.g., 0.0-1.0)) that provides a numerical measure of the probability that the LLM-assigned enrichment is accurate. The confidence score may be validated to ensure consistent and positive correlation. Following this validation, the ACH transaction tagging device 302 may utilize only the enrichments that are assigned a confidence score above a certain threshold, in order to yield a predetermined estimated accuracy.

FIG. 5 illustrates a flow diagram 500 of a process for enriching raw transaction data by appending transactional tags that contain useful information for categorizing and analyzing ACH transactions, according to an embodiment. FIG. 5 illustrates a detailed flow diagram of steps S402 through S414 of FIG. 4, according to an embodiment. As illustrated by FIG. 5, source data 510, which includes a raw transaction level dataset, goes through a pre-enrichment data aggregation module 512, in which a respective merchant name, a respective transaction description, and a respective SEC code are aggregated for each respective transaction. The aggregated data from the pre-enrichment data aggregation module 512 then moves to a clean-up function module 514 that, at module 516, leverages computer code to clean names and descriptions (e.g., by removing punctuations and acronyms (e.g., LLC, CORP, etc.)). The cleaned-up data is then transmitted from the clean-up function module 514 to the enrichment rule set module 522. At the rule set driver files module 518, specific rule mapping is developed that is in conjunction with the type of business or practice that will be analyzing the data. At the dynamic rule set creation module 520 the rules that were mapped at the rule set driver files module 518 are generated and standardized in such a way that they may be applied to the transaction data.

At the enrichment rule set module 522, the rules generated at the rule set creation module 520 are applied to the cleaned-up data. The enrichment rule set module 522 is configured to generate respective standardized names at the name standardization module 524. The respective standardize names may be based on the respective clean names generated at the clean-up function module 514. In an embodiment, the enrichment rule set module 522 may standardize multiple varieties of a merchant's name to a single standard name. This name standardization may allow for reporting on merchant level volumes to be representative of all transactions with that merchant. The enrichment rule set module 522 is also configured to generate respective industry types at the industry module 526. Industry type may provide additional context for the transaction, the merchant that is involved, and other details in transaction description. The respective industry types may be based on the respective clean names and the respective transaction descriptions. For example, for a transaction having PaYr in the transaction description field, the enrichment rule set module 522 may have a rule that derives that PaYr means payroll, so using a combination of the standard merchant name and the transaction description, the transaction may be assigned the appropriate industry. Additionally, the enrichment rule set module 522 is configured to generate respective use cases at the use case module 528. Use cases may provide additional context for the purpose or reason for transaction. The respective use cases may be based on the respective clean names, the respective transaction descriptions, and the respective industry types. Moreover, the enrichment rule set module 522 is configured to generate respective transaction types at the transaction type module 530. Transaction type may provide additional context for the type of transaction (e.g., single payment, recurring payment, digital wallet, or transfer). The respective transaction types may be based on the respective clean names, the respective transaction descriptions, and the respective industry types.

Each of the standardized names, the industry types, the use cases, and the transaction types are transmitted respectively from the name standardization module 524, the industry module 526, the use case module 528, and the transaction type module 530 to the data asset module 534. Additionally, the data asset module 534 receives historical enriched data from the transaction level data asset module 532. The data asset module 534 may store each of the respective categorized data as part of a lookup table, so that the data can be easily searched, analyzed, and applied.

Data that was not enriched (i.e., non-enriched data) at the enrichment rule set module 522 is then transmitted from the data asset module 534 to the non-enriched data module 536. Meanwhile, the data that was enriched (i.e., enriched data) at the enrichment rule set module 522 is then transmitted from the data asset module 534 to the enriched data module 538. The enriched data is then transmitted to an LLM model initialization module 542 for training. The LLM model initialization module 542 also receives a prompt 540 for tagging/labeling the data. For example, the prompt may be for the LLM to provide enrichment tags/labels to cleaned attributes. In an embodiment, the prompt 540 may facilitate tuning and sampling of data to produce the final data asset products. Additionally, the LLM model initialization module 542 receives additional enrichment data from a fine tuning module 544. The finetuning module may supply the LLM model initialization module 542 with reviewed enrichment data as well as positive prompts for ensuring understanding of correct versus incorrect tags. The non-enriched data is then fed into an LLM model execution module 546 along with all the data from the LLM model initialization module 542. In an embodiment, the LLM model initialization module 542 may compare the body of already enriched transactions to the unenriched transactions and determine if the unenriched transactions look similar in nature to the enriched transactions.

Next, all the data compiled at the LLM model execution module 546 is transmitted to a model-based data enrichment and assessment module 555. At the model based data enrichment and assessment module 555, the data from the LLM model execution module 546 is first processed at the modeled enrichment module 548 to generate enrichments (e.g., a standardized name 550, an industry type 552, a use case 554, and a transaction type 556) to the non-enriched data, as well as respective confidence scores for each generated enrichment. At the sampling module 558, enrichments may be grouped together based on respective confidence scores and an accuracy threshold may be identified for determining the accuracy of the model. Once the enrichments are grouped and a threshold is identified, the confidence score of each respective grouping is compared to the threshold to determine the accuracy of each at the accuracy review module 560. In other words, the enrichments will not be taken at face value, and instead there will be sampling and assessment to determine if the enrichments are above a certain confidence level. Everything above a confidence threshold will be output from the model and everything below the confidence threshold will be continually fine-tuned and refined to achieve better and more accurate results. Then, all the enrichments above the established accuracy threshold are transmitted to a model enriched data table 562, which feeds data back to the finetuning module 544 and the data asset module 534 for subsequent training. Thus, anything that passes the sampling and accuracy review will be fed back into data asset module 534, making the system and model smarter, as more enriched data is fed into the data asset module 534.

Accordingly, with this technology, an optimized process for enriching raw transaction data by appending transactional tags that contain useful information for categorizing and analyzing ACH transactions is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for tagging an automated clearing house (ACH) transaction, the method being implemented by at least one processor, the method comprising:
accessing, by the at least one processor, raw transaction data that includes a respective merchant name and a respective transaction description for each respective transaction from the raw transaction data;
removing, by the at least one processor, extraneous characters from the raw transaction data;
separating, by the at least one processor, the raw transaction data into a first subset of raw transaction data and a second subset of raw transaction data;
applying, by the at least one processor, a set of enrichment rules to the first subset of the raw transaction data to generate a first enriched data set, wherein the applying of the set of enrichment rules includes assigning a respective standardized merchant name, assigning a respective industry, assigning a respective use case, and assigning a respective transaction type to each respective transaction from the first subset of the raw transaction data, and wherein the first enriched data set is a consolidation of the results from the applying of the set of enrichment rules;
transmitting, by the at least one processor, the first enriched data set to a data asset set;
training, by the at least one processor, a large language model (LLM) using the data asset set to perform assigning standardized merchant names, assigning industries, assigning use cases, and assigning transaction types to unenriched data; and
assigning, by the at least one processor via the LLM, a respective standardized merchant name, a respective industry, a respective use case, and a respective transaction type to each respective transaction from the second subset of the raw transaction data to generate a second enriched data set, wherein the second enriched data set is a consolidation of the results from the assigning.

2. The method of claim 1, further comprising:
calculating, by the at least one processor via the LLM, a respective confidence score for each of the assigning of the respective standardized merchant name, the assigning of the respective industry, the assigning of the respective use case, and the assigning of the respective transaction type for each respective transaction from the second enriched data set;
determining, by the at least one processor via the LLM, whether each respective confidence score is above a predetermined threshold; and
transmitting, by the at least one processor, each respective assignment having a corresponding confidence score above the predetermined threshold to a model enriched data set.

3. The method of claim 2, wherein each respective assignment having a corresponding confidence score below the predetermined threshold is transmitted back to the LLM model for re-assigning of a respective standardized merchant name, a respective industry, a respective use case, and a respective transaction type.

4. The method of claim 2, wherein the model enriched data set is fed into the data asset set and used for the training of the LLM model.

5. The method of claim 1, wherein the LLM model is configured to compare each respective transaction of the second subset of raw transaction data to each respective transaction of the data asset set to determine whether the respective transaction of the second subset of raw transaction data is similar to the respective transaction of the data asset set, and wherein the assigning is based on each respective transaction of the data asset set that is determined to be similar to the respective transaction of the second subset of raw transaction data.

6. The method of claim 1, wherein the extraneous characters include at least one from among at least one punctuation and at least one acronym.

7. The method of claim 1, wherein the assigning of the respective industry is based on the respective merchant name and the respective transaction description.

8. The method of claim 1, wherein the assigning of the respective use case is based on the respective merchant name, the respective transaction description, and the respective assigned industry.

9. The method of claim 1, wherein the assigning of the respective transaction type is based on the respective merchant name, the respective transaction description, and the respective assigned industry.

10. A computing apparatus for tagging an automated clearing house (ACH) transaction, the computing apparatus comprising:
a processor;
a memory; and
a communication interface coupled to each of the processor and the memory,
wherein the processor is configured to:
access raw transaction data that includes a respective merchant name and a respective transaction description for each respective transaction from the raw transaction data;
remove extraneous characters from the raw transaction data;
separate the raw transaction data into a first subset of raw transaction data and a second subset of raw transaction data;
apply a set of enrichment rules to the first subset of the raw transaction data to generate a first enriched data set, wherein the applying of the set of enrichment rules includes assigning a respective standardized merchant name, assigning a respective industry, assigning a respective use case, and assigning a respective transaction type to each respective transaction from the first subset of the raw transaction data, and wherein the first enriched data set is a consolidation of the results from the applying of the set of enrichment rules;
transmit the first enriched data set to a data asset set;
train a large language model (LLM) using the data asset set to perform assigning standardized merchant names, assigning industries, assigning use cases, and assigning transaction types to unenriched data; and
assign, via the LLM, a respective standardized merchant name, a respective industry, a respective use case, and a respective transaction type to each respective transaction from the second subset of the raw transaction data to generate a second enriched data set, wherein the second enriched data set is a consolidation of the results from the assigning.

11. The computing apparatus of claim 10, wherein the processor is further configured to:
calculate, via the LLM, a respective confidence score for each of the assigning of the respective standardized merchant name, the assigning of the respective industry, the assigning of the respective use case, and the assigning of the respective transaction type for each respective transaction from the second enriched data set;
determine, via the LLM, whether each respective confidence score is above a predetermined threshold; and
transmit each respective assignment having a corresponding confidence score above the predetermined threshold to a model enriched data set.

12. The computing apparatus of claim 11, wherein each respective assignment having a corresponding confidence score below the predetermined threshold is transmitted back to the LLM model for re-assigning of a respective standardized merchant name, a respective industry, a respective use case, and a respective transaction type.

13. The computing apparatus of claim 11, wherein the model enriched data set is fed into the data asset set and used for the training of the LLM model.

14. The computing apparatus of claim 10, wherein the LLM model is configured to compare each respective transaction of the second subset of raw transaction data to each respective transaction of the data asset set to determine whether the respective transaction of the second subset of raw transaction data is similar to the respective transaction of the data asset set, and wherein the assigning is based on each respective transaction of the data asset set that is determined to be similar to the respective transaction of the second subset of raw transaction data.

15. The computing apparatus of claim 10, wherein the extraneous characters include at least one from among at least one punctuation and at least one acronym.

16. The computing apparatus of claim 10, wherein the assigning of the respective industry is based on the respective merchant name and the respective transaction description.

17. The computing apparatus of claim 10, wherein the assigning of the respective use case is based on the respective merchant name, the respective transaction description, and the respective assigned industry.

18. The computing apparatus of claim 10, wherein the assigning of the respective transaction type is based on the respective merchant name, the respective transaction description, and the respective assigned industry.

19. A non-transitory computer readable storage medium storing instructions for tagging an automated clearing house (ACH) transaction, the storage medium comprising executable code which, when executed by a processor, causes the processor to:
access raw transaction data that includes a respective merchant name and a respective transaction description for each respective transaction from the raw transaction data;
remove extraneous characters from the raw transaction data;
separate the raw transaction data into a first subset of raw transaction data and a second subset of raw transaction data;
apply a set of enrichment rules to the first subset of the raw transaction data to generate a first enriched data set, wherein the applying of the set of enrichment rules includes assigning a respective standardized merchant name, assigning a respective industry, assigning a respective use case, and assigning a respective transaction type to each respective transaction from the first subset of the raw transaction data, and wherein the first enriched data set is a consolidation of the results from the applying of the set of enrichment rules;
transmit the first enriched data set to a data asset set;
train a large language model (LLM) using the data asset set to perform assigning standardized merchant names, assigning industries, assigning use cases, and assigning transaction types to unenriched data; and
assign, via the LLM, a respective standardized merchant name, a respective industry, a respective use case, and a respective transaction type to each respective transaction from the second subset of the raw transaction data to generate a second enriched data set, wherein the second enriched data set is a consolidation of the results from the assigning.

20. The storage medium of claim 19, wherein the executable code further causes the processor to:
calculate, via the LLM, a respective confidence score for each of the assigning of the respective standardized merchant name, the assigning of the respective industry, the assigning of the respective use case, and the assigning of the respective transaction type for each respective transaction from the second enriched data set;
determine, via the LLM, whether each respective confidence score is above a predetermined threshold; and
transmit each respective assignment having a corresponding confidence score above the predetermined threshold to a model enriched data set.
